(19) United States
(12) Patent Application Publication
(10) Pub. No.: US 2006/0092203 A1
(43) Pub. Date: May 4, 2006

(54) Ink jet printhead having aligned nozzles for complementary printing in a single pass

(75) Inventors: Donald J. Drake, Rochester, NY (US); Dale R. Ims, Webster, NY (US); Peter A. Torpey, Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/980,353

(22) Filed: Nov. 3, 2004

(51) Int. Cl. B41J 29/38

(52) U.S. Cl. 347/12

(57) ABSTRACT

An ink jet printer has a roofshooter type printhead with first and second aligned nozzle arrays that ejects ink droplets onto a recording medium in a complete image swath during a single pass. The ink droplets from the first array of nozzles print selected pixels of an image in each line of pixels on the recording medium, and the ink droplets from the second array of nozzles print the remaining pixels of the image in each line of pixels not printed by the first array of nozzles, thereby providing a printhead capable of complementary printing of a complete image swath in a single pass that eliminates the signature effect in ink jet printing.

### BACKGROUND

An exemplary embodiment of this application relates to an ink jet printer having a printhead and controller that enables high-quality, signature-eliminating printing in a single pass. More particularly, the exemplary embodiment relates to an ink jet printhead having a droplet ejecting structure with two arrays of nozzles, the individual nozzles in one array of nozzles being positioned in alignment with corresponding nozzles in the second array in the scanning or process direction.

Droplet-on-demand ink jet printing systems eject ink droplets from printhead nozzles in response to pressure pulses generated within the printhead by either piezoelectric devices or thermal transducers, such as resistors. The ejected ink droplets are propelled to specific locations on a recording medium, commonly referred to as pixels, where each ink droplet forms a spot on the recording medium. The printheads contain ink in a plurality of channels, usually one channel for each nozzle, which interconnect an ink reservoir in the printhead with the nozzles.

In a thermal ink jet printing system, for which the exemplary embodiment of this application is an example, the pressure pulse is produced by applying an electrical current pulse to a resistor typically associated with each one of the channels. Each resistor is individually addressable to heat and momentarily vaporize the ink in contact therewith. As a voltage pulse is applied across a selected resistor, a temporary vapor bubble grows and collapses in the associated channel, thereby displacing a quantity of ink from the channel so that it bulges through the channel nozzle. The ink bulging through the nozzle is ejected from the nozzle as a droplet during the bubble collapse on the resistor. The ejected droplet is then propelled to a recording medium. When the ink droplet hits the targeted pixel on the recording medium, the ink droplet forms a spot thereon. The channel from which the ink droplet was ejected is then refilled by capillary action, which, in turn, draws ink from an ink supply container.

In a typical piezoelectric ink jet printing system, the pressure pulses that eject ink droplets are produced by applying an electric pulse to the piezoelectric devices, one of which is typically located within each one of the ink channels. Each piezoelectric device is individually addressable to cause it to bend or deform and pressurize the volume of ink in contact therewith. As a voltage pulse is applied to a selected piezoelectric device, a quantity of ink is displaced from the ink channel and a droplet of ink is mechanically ejected from the nozzle associated with each piezoelectric device. Just as in thermal ink jet printing, the ejected droplet is propelled to a pixel target on a recording medium. The channel from which the ink droplet was ejected is refilled by capillary action from an ink supply. For an example of a piezoelectric ink jet printer, refer to U.S. Pat. No. 3,946,398.

There are two general types of structures for thermal ink jet printheads, and they are commonly referred to as either an edge shooter structure or a roofshooter structure. In an edge shooter printhead structure, ink droplets are ejected from nozzles in a direction parallel to the flow of ink in the channels and parallel to the surface of the bubble-generating resistors in the printheads, such as, for example, the printhead disclosed in U.S. Pat. No. 4,899,181 and U.S. Pat. No. 4,994,826. In contrast, the roofshooter printhead structure ejects ink droplets from nozzles in a direction normal to the surface of the bubble-generating resistors, such as, for example, the printhead disclosed in U.S. Pat. No. 4,568,953 and U.S. Pat. No. 4,789,425.

A thermal ink jet printhead can include one or more printhead die assemblies, each having a heater portion and a channel portion. The channel portion includes an array of ink channels that bring ink into contact with the bubble-generating resistors, which are correspondingly arranged on the heater portion. In addition, the heater portion may also have integrated addressing electronics and driver transistors. The array of channels in a single die assembly is not sufficient to cover the full width of a page of recording medium, such as, for example, a standard sheet of paper. Therefore, a printhead having only one die assembly is scanned across the page of recording medium while the recording medium is held stationary and then the recording medium is advanced between scans. Alternatively, multiple die assemblies may be butted together to produce a full width printhead, such as, for example, the printhead disclosed in U.S. Pat. No. 4,829,324 and U.S. Pat. No. 5,221,397.

Because thermal ink jet printhead nozzles typically eject ink droplets that produce spots of a single size on the recording medium, high quality printing requires the ink channels and associated nozzles and corresponding printhead resistors to be fabricated at a high resolution, such as, for example, 600 per inch. Accordingly, the printhead of the exemplary embodiment of this application has resolution of at least 600 nozzles per inch.

The ink jet printhead may be incorporated into a carriage type printer or a full width array type printer. The carriage type printer may have a printhead having a single die assembly or several die assemblies abutted together for a partial width size printhead. Since both single die and multiple-die, partial width printheads function substantially the same way in a carriage type printer, only the printer with a single die printhead will be discussed. The only difference, of course, is that the partial width size printhead will print a larger swath of information. The single die printhead, containing the ink channels and nozzles, can be sealingly attached to a disposable ink supply cartridge, and the combined printhead and cartridge assembly is replaceably attached to a carriage that is reciprocated to print one swath of information at a time, while the recording medium is held stationary. Each swath of information is equal to the height of the column of nozzles in the printhead. After a swath is printed, the recording medium is stepped a distance at most equal to the height of the printed swath, so that the next printed swath is contiguous or overlaps with the previously printed swath. This procedure is repeated until the entire image is printed.

In contrast, the page width printer includes a stationary printhead having a length sufficient to print across the width of sheet of recording medium. The recording medium is continually moved past the full width printhead in a direction substantially normal to the printhead length and at a constant or varying speed during the printing process. Another example of a full width array printer is described, for example, in U.S. Pat. No. 5,192,959.

Ink jet printing systems typically eject ink droplets based on information received from an information output device, such as, a personal computer. Typically, this received information is in the form of a raster, such as, for example, a full page bitmap or in the form of an image written in a page description language. The raster includes a series of scan lines comprising bits representing individual information elements or pixels. Each scan line contains information sufficient to eject a single line of ink droplets across the recording medium in a linear fashion from one nozzle. For example, ink jet printers can print bitmap information as received or can print an image written in the page description language once it is converted to a bitmap of pixel information.

U.S. Pat. No. 6,457,798 discloses an ink jet printhead having a roofshooter construction with two arrays of aligned nozzles. Each nozzle has two droplet producing resistors or heaters between the ink supply and the nozzles. Each nozzle in each array can selectively eject ink droplets of either a large or small size onto a recording medium, depending on whether a voltage is applied to one of the two heaters or both. Various combinations of small and large droplets are ejected onto a recording medium during a single pass of the printhead to enable printing of pixels having up to six gray levels.

U.S. Pat. No. 6,089,692 discloses an ink jet printer for producing gray scale image pixels on a recording medium. A plurality of nozzles is formed in a one-dimensional or linear array. A plurality of control circuits applies electrical pulses to annular resistors that surround each nozzle, so that each nozzle will eject an ink droplet for each pulse onto the recording medium. A transport mechanism provides relative movement between the nozzle array and the recording medium in a direction normal to the linear array of nozzles. A transport control system provides intermittent relative movement of the recording medium and repeatedly pauses the relative movement while a plurality of droplets is selectively ejected by each nozzle of the nozzle array onto the recording medium for each pixel to be printed.

U.S. Pat. No. 6,375,294 discloses an ink jet printing system that prints variable density cells containing a plurality of different sized spots produced by ink droplets ejected from a plurality of large, mid-sized, and small nozzles in a printhead. Each of the plurality of large, mid-sized, and small spots produced by the nozzles are placed on different grids, where the grid spacing for the small spots is less than the grid spacing of the large spots and is offset from it.

US 2003/0103093 is a published patent application that discloses a method of ink jet printing of an image having super pixels. Each super pixel comprises a combination of spots on a print medium that are independently controlled with respect to spot size, spot density, and at least two spots in the super pixel overlap. The super pixels contain at least two spots of different sizes and two spots of different densities. According to a preferred embodiment, at least two inks are used with different gray levels.

US 2003/0142151 is a published patent application that discloses an ink jet printing apparatus and method that performs multilevel printing. The multilevel printing is accomplished by using a plurality of types of inks which have different densities for similar colors and by changing the types of inks and the number ink droplets in printing each pixel. The printing apparatus has an input means for inputting information on the relative densities for the respective inks, a table generating means for generating an ink distribution table, and a combination selection means for selecting the combination to be used to print each pixel based on the ink distribution table. The distribution table defines the combination of the types of inks and the numbers of ink droplets on the basis of the relative ink densities.

One of the major productivity limitations of ink jet printing is that the print quality resulting from single pass printing is not acceptable because of a printing ‘signature’ resulting from small but stable misdirectionality of the ejected ink droplets. This printing signature produces discernible light and dark bands in the information printed on the recording medium and is generally unacceptable. Currently, for high quality printing modes, most ink jet printers use a multi-pass printing mode to complete a swath of the document, wherein the multi-pass mode forms each pixel line with ink droplets ejected from at least two different printhead nozzles during different scans across the recording medium. This well known printing technique, known to those skilled in the art as “checkerboard” printing, may be explained as follows. For a printhead whose array of droplet ejectors are enumerated sequentially from one end to the other, a checkerboard printing mode would be achieved by firing the odd numbered ejectors as the printhead passes a first pixel location in each line of pixels in the scan or process direction. Then, the even numbered ejectors are fired as the printhead passes a succeeding pixel location in the scan direction. The appearance of the printed image, after a first pass of a printhead that prints what is to be a solid area, thus looks like a checkerboard. A second pass of the printhead is required to fill in the pixels that were skipped in the first pass. Checkerboard printing mitigates and subdues the printing signature effect by introducing noise into the systematic misdirectionality, so that the quality of the printed information is acceptable. However, the cost for the improvement in print quality, which the multi-pass, checkerboard printing mode provides, is reduced throughput, since an additional pass is required of the printhead to fill in the checkerboard pattern. Thus, it is the aim of the exemplary embodiment of this application to provide a printhead for signature eliminating printing in a single pass.

### SUMMARY

It is an object of an exemplary embodiment of this application to provide an ink jet printhead having a roofshooter structure with two aligned arrays of nozzles. The nozzle alignment is in the process or scanning direction, and each nozzle in each array only prints selected different pixels of an image in each line of pixels on the recording medium, so that the printhead prints in a complementary printing pattern during a single pass.

In one aspect of the exemplary embodiment, there is provided a printhead for an ink jet printer that prints pixels on a recording medium in a complementary printing pattern during a single pass, comprising: a first and a second array of nozzles in the printhead, said first and second arrays of nozzles being substantially parallel to each other, and the nozzles in said first array of nozzles being in alignment with the nozzles in said second array of nozzles in a printing process direction; and a printer controller for effecting selective ejection of ink droplets from each of the nozzles in said first and second arrays of nozzles during movement of said printhead in said printing process direction, so that said ink droplets from said first array of nozzles prints selected pixels of an image in each line of pixels and said ink droplets from said second array of nozzles prints the remaining pixels of said image in each line of pixels, thereby said printing by said printhead mitigates the signature effect and other systematic printing defects while printing a complete image in a single pass.

In one embodiment, there is provided a method of complementary printing during a single pass by a printhead of an ink jet printer, comprising the steps of: providing a first and a second array of nozzles in said printhead, said first and second array of nozzles being substantially parallel to each other; aligning the nozzles of said first array of nozzles with said second array of nozzles in a printing process direction; providing a printer controller for controlling the printing by the printhead; selectively ejecting ink droplets from each of the nozzles in said first and second arrays of nozzles during movement of said printhead is said printing process direction; directing the ink droplets from said first array of nozzles to selected pixels of an image in each line of pixels on a recording medium; directing the ink droplets from said second array of nozzles to remaining pixels of said image in each line of pixels on said recording medium that were not printed by the ink droplets from said first array of nozzles, so that a complete image swath is produced in a single pass.

### BRIEF DESCRIPTION OF THE DRAWINGS

An exemplary embodiment of this application will now be described, by way of example, with reference to the accompanying drawings, in which like reference numerals refer to like elements, and in which:

FIG. 1 is a schematic side elevation view of an ink jet printer having a roofshooter type printhead usable with printing systems and methods according to the exemplary embodiment of this application;

FIG. 2 is a plan view of the printhead nozzle face showing two aligned linear arrays of nozzles;

FIG. 3 is a schematic cross-sectional view of the roofshooter type printhead as viewed along view line 3-3 in FIG. 2;

FIG. 4 is a plan view of the complementary printing during a single pass by the ink jet printhead of FIG. 3;

FIG. 5 is a plan view of one specific example of complementary printing in a single pass by the printhead of FIG. 3;

FIG. 6 is a plan view of the nozzle face of a piezoelectric ink jet printhead, showing two arrays of nozzles that are equivalent to the linear arrays of nozzles in the nozzle face of FIG. 2;

FIG. 7 is a plan view of a specific example of complementary printing in a single pass by the printhead shown in FIG. 6;

FIG. 8 is a plan view of various gray levels printable by the ink jet printhead shown in FIGS. 2 and 6, according to one exemplary embodiment of this application; and

FIG. 9 is a plan view of various gray levels printable by the ink jet printhead shown in FIGS. 2 and 6, according to another exemplary embodiment of this application.

### DESCRIPTION OF THE PREFERRED EMBODIMENT

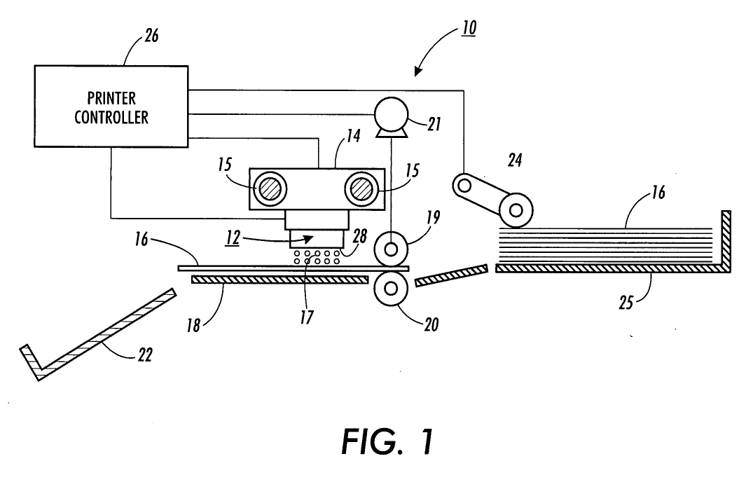

In FIG. 1, a schematic representation of a carriage type thermal ink jet printer 10 is shown in a side elevation view. The ink jet printer 10 employs a translating thermal ink jet printhead 12 that has a roofshooter structure mounted on a carriage 14 which travels back and forth across the recording medium 16 on guide rails 15. In the orientation of the printhead shown in FIG. 1, the printhead translation is along guide rails that are normal to the surface of the drawing. Alternatively, the printer 10 may employ a fixed full width printhead (not shown) wherein the recording medium is continually moved there past at a constant or variable speed by feed rollers (not shown).

The printhead 12 ejects ink droplets 17 onto the recording medium 16 residing on printing platen 18 one swath at a time and feed rollers 19 and 20, one of which is driven by an electric motor 21, is capable of precise motion quality. The electric motor 21 is used both to register and step the recording medium 16 past the printhead 12 after each swath is printed until the entire surface area of the recording medium is printed or until all the information is printed, if less than a page. When the printing on the recording medium has been completed, the recording medium with the printed information is delivered to the catch tray 22. A typical document feeder 24 moves single sheets of recording medium 16 on demand from the printer controller 26 to the feed rollers 19, 20 from a cassette (not shown) or stack of recording medium 16 in supply tray 25. For a more detailed description of a printhead having a roofshooter structure refer to U.S. Pat. No. 4,568,953 and U.S. Pat. No. 4,789,425, the relevant portions of which are incorporated herein by reference. The printer controller 26 causes the timely delivery of a recording medium 16 to the printing platen 18 and the printhead 12 to print the information on it, as discussed later.

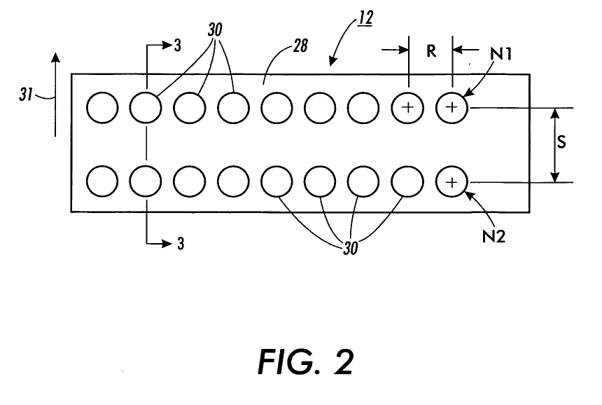

A plan view of the nozzle face 28 of the printhead 12 is depicted in FIG. 2, showing the two linear arrays of nozzles 30 aligned in the printing process direction, as indicated by arrow 31. One linear array of nozzles is identified as N1, and the other linear array of nozzles is identified as N2. Although the two arrays of nozzles N1, N2 are shown in the preferred embodiment of FIG. 2 as being in the single nozzle face 28 of printhead 12, each array of nozzles could be in separate nozzle faces of separate parts or printheads (not shown). The separate printheads would have to be aligned in a manner so that their respective array of nozzles are aligned in the process printing direction. The nozzle diameter and the spacing between nozzles in each array are preferably that necessary to provide a printing resolution of at least 600 spots per inch (spi). Thus, the nozzle diameter in the exemplary embodiment is about 20 μm, and the center-to-center spacing as indicated by “R” is about 42.5 μm. The distance between linear arrays of nozzles, as indicated by “S”, is about 500 μm.

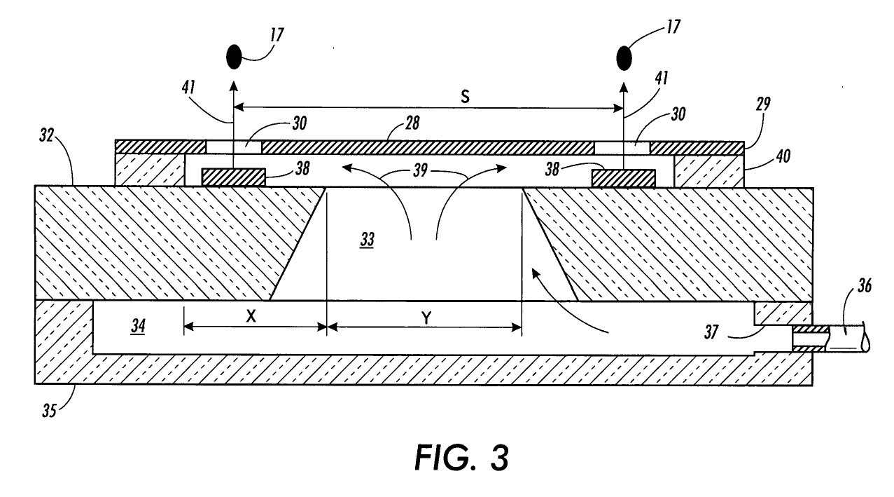

In FIG. 3, a schematic cross-sectional view of the printhead 12 having a roofshooter structure is shown, as viewed along view line 3-3 in FIG. 2. A heater plate 32 formed from a (100) silicon wafer (not shown) has an anisotropically etched opening 33 there through that serves as an ink inlet from the ink reservoir 34 formed in bottom plate 35. A conduit 36 connects an ink supply (not shown) to the ink reservoir 34 by aperture 37 in the bottom plate. Bottom plate 35 may be any suitable ink resistant material, such as, for example, glass or silicon. The surface of the heater plate opposite the surface attached to the bottom plate 35 has two linear arrays of heating elements or resistors 38, one array on each side of the ink inlet 33. A flow directing barrier layer 40 is formed on or attached to the heater plate 32 to direct the ink to each of the resistors 38, as indicated by arrows 39. A nozzle plate 29 having a nozzle face 28 with the two linear arrays of nozzles 30 therein is adhered to the barrier layer 40, thus completing the basic construction of the roofshooter type printhead 12. The resistors are formed on the heater plate, so that one resistor is directly below each nozzle. Arrows 41 show the ejection trajectory of the ink droplets 17 from the nozzles 30 as being normal to the resistors 38. Integrating addressing electronics and driver transistors (not shown) are also provided on the heater plate surface containing the bubble-generating resistors and selectively apply voltage pulses to the resistors in response to signals from the printer controller 26, shown in FIG. 1. Each voltage pulse applied to the selected resistor ejects an ink droplet. The printer controller 26 may contain either the complementary or gray level printing program modes or both modes that could be selectable by the printer operator for either complementary printing during a single pass or gray level printing during a single pass. The complementary printing mode and the gray level printing mode are both enabled by the printhead 12.

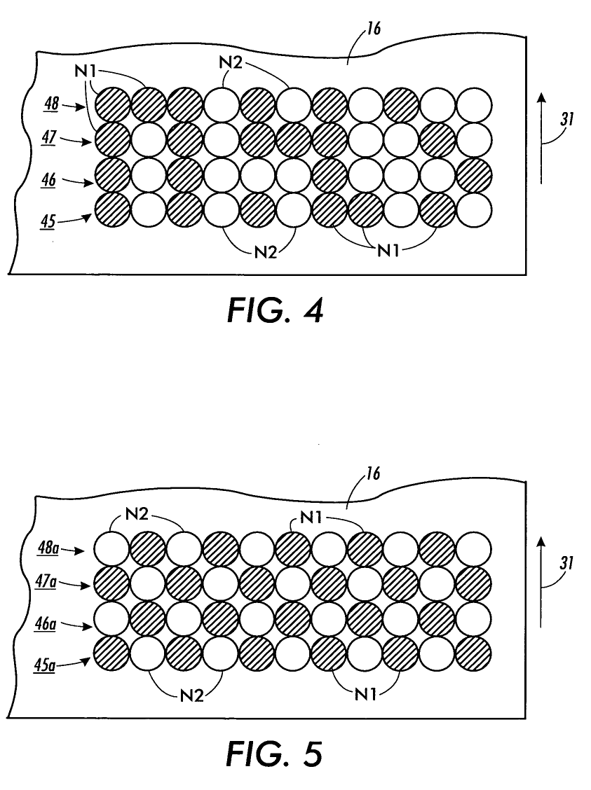

Referring next to FIG. 4, four lines of spots or pixels 45, 46, 47, and 48 are shown printed in a complementary printing pattern on the recording medium 16. Each of the printed spots in each line of pixels is printed in a single pass of the printhead. As the printhead is moved in the printing process or scanning direction, as indicated by arrow 31, ink droplets are ejected and propelled to the pixel locations on the recording medium. Referring also to FIG. 2 and for illustration purposes, the spots printed from the nozzles 30 in linear array N1 are identified as N1, and the spots printed from nozzles 30 in linear array N2 are identified as N2. Accordingly, pixel line 45 is printed first, pixel line 46 is printed second, pixel line 47 is printed third, and pixel line 48 is printed last. Thus, FIG. 4 shows a general example of complementary printing in which the geometric alteration of spots is not a constraint. Complementary printing has the advantage of randomizing the use of ink droplets from both arrays of nozzles N1, N2 in order to hide or minimize signature or systematic printing defects.

In FIG. 5, four lines of pixels 45a, 46a, 47a, and 48a are shown on recording medium 16 as printed in one specific implementation of complementary printing; viz., the so called checkerboard printing pattern. The generic printing pattern shown in FIG. 4 and the specific implementation of complementary printing (checkerboard printing) as shown in FIG. 5 are readily produced by the aligned arrays of nozzles N1, N2 in printhead 12. In fact, checkerboard printing is just the simplest and most easily implemented signature-correcting printing pattern available with the complementary printing mode provided by the printer controller 26. If the printhead nozzles 30 are enumerated sequentially from one end of the array of nozzles to the opposite end, a checkerboard print pattern is achieved by ejecting ink droplets from odd numbered nozzles in the first nozzle array N1, as the first array of nozzles passes the first line of pixels 45a in the scan direction 31. Then, ink droplets are ejected from the even numbered nozzles as the first array of nozzles passes the second line of pixels 46a. Ink droplets from the odd numbered nozzles in the first array of nozzles prints the third line of pixels 47a, and ink droplets from the even numbered nozzles in the first array of nozzles prints the fourth line of pixels 48a. The appearance of the printed image after a single pass by only one of the two arrays of nozzles of the printhead, when printing what is to be a solid area, thus looks like an actual checkerboard.

Of course, the second array of nozzles N2 of the printhead 12 is required to fill in the pixels that were skipped by the first array of nozzles N1, so that the signature effects are diluted by addition of spots formed by ink droplets ejected from different printhead nozzles. Therefore, those skilled in the art will recognize that the checkerboard printing pattern is one instantiation of the general method of single pass printing by a printhead having two arrays of nozzles aligned in the printing process or scanning direction, where a logical mask is used to determine which pixel locations are to be printed by the first array of nozzles N1, and a second logical mask, the logical complement of the first mask, is used to determine the pixel locations to be printed by the second array of nozzles N2.

As shown in FIG. 5, each array of nozzles prints one half of the checkerboard pixels or spots in each line of pixels, thereby enabling full checkerboard printing in a single pass. Note that every other spot in each line is printed from nozzles of different arrays N1, N2, and the spots in each line in the scanning direction 31 is also printed from nozzles of different arrays. This provides the print quality advantages of checkerboard printing with the throughput of single pass, non-checkerboard printing. It has reliability advantages as well, since it is known that the print quality resulting when one of the two checkerboarding nozzles is non-functional has been found acceptable in the checkerboard print mode. Such a printing technique with a printer having a full width printhead can enable very high productivity single pass printing with enhanced reliability.

Another advantage of the printhead having two aligned linear arrays of nozzles according to the exemplary embodiment of this application is that the single pass checkerboarding can be printed at higher printhead scan speeds. This is because each nozzle is only required to print every other droplet in a line of pixels, and the frequency response requirement is one half that of a single nozzle array printhead. The concern that firing or ejecting droplets from adjacent nozzles in a 600 spi nozzle array would create unwanted interactions, not only at the nozzle face, but also in the adjacent droplets on the recording medium is eliminated, because the printhead 12 of the exemplary embodiment prints in a checkerboard mode and adjacent nozzles in each linear array N1,N2 never eject droplets simultaneously. Thus, the interactions of concern are greatly minimized. In addition, the printhead 12 has about twice the expected resistor lifetime of a single 600 spi printing printhead because the resistor only ejects half the number of droplets in a line of pixels.

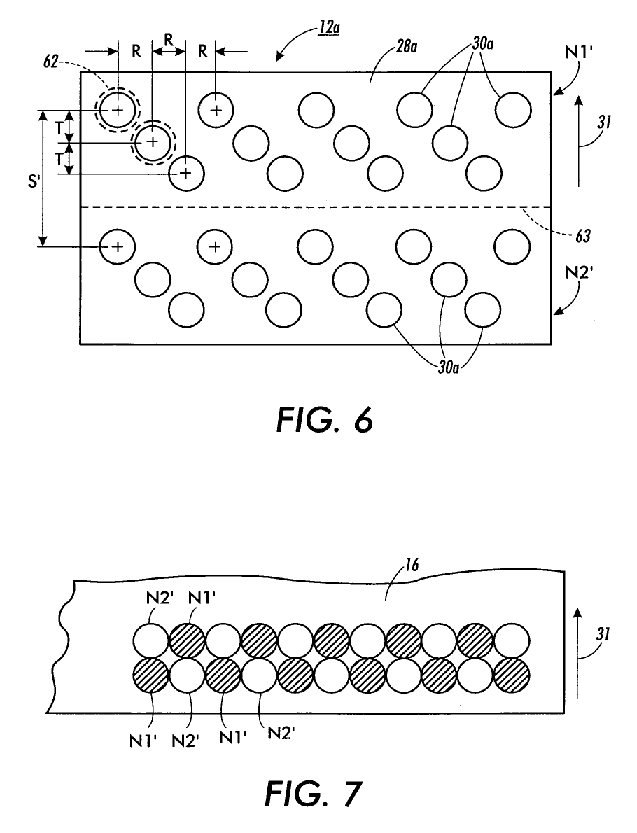

In FIG. 6, a plan view of nozzle face 28a of a piezoelectric ink jet printhead 12a is shown. Because piezoelectric devices are typically larger than resistors used in thermal ink jet printheads, it is necessary to offset the droplet ejecting nozzles from one another to achieve appropriate spacing required for high resolution printing, such as at least 600 spi. The nozzle face 28a has two arrays N1′, N2′ that are equivalent to the two arrays of nozzles in nozzle face 28 shown in FIG. 2, and in the scanning direction 31, provide the same printing resolution. Each nozzle array in FIG. 6 is shown as having three rows of nozzles 30a, but the number of rows of nozzles could be more or less depending on the desired printing resolution and the size of the piezoelectric device 62 used as the droplet ejector. The nozzles 30a in each row have the same nozzle diameter and center-to-center spacing R as that of nozzles in nozzle face 28 in FIG. 2. Thus, the diameter of the nozzles 30a is about 20 μm, and the center-to-center spacing R is about 42.5 μm. In the direction perpendicular to the scanning direction 31, the center-to-center spacing “T” indicates the offset necessary to accommodate the size of the piezoelectric devices 62 that are shown in dashed line. The spacing S′ between aligned nozzles 30a in each equivalent array of N1′, N2′, may be any dimension necessary to permit the alignment of the nozzles. Dashed line 63 in nozzle face 28a serves to delineate the two separate nozzle arrays and indicates that each nozzle array may be in separate printheads (not shown).

FIG. 7 is a plan view of a specific example of complementary printing in a single pass by the piezoelectric printhead 12a, specifically, a checkerboard pattern is shown. FIG. 7 is shown in alignment with the nozzle face 28a of FIG. 6 in order to more easily depict that the ink droplets ejected from the offset nozzles 30a in each array of nozzles N1′, N2′ produce the same printing resolution as the linear nozzle arrays of the thermal ink jet printhead 12, shown in FIG. 2.

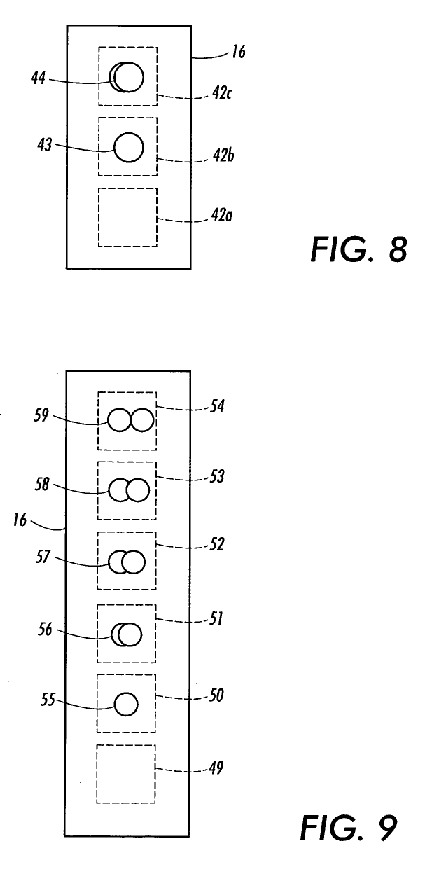

In FIG. 8, a plan view of the gray levels printable by the ink jet printhead 12 is shown, when the printer controller 26 is programmed for gray level printing. If desired, the printer controller 26 could have both complementary and gray level printing mode capabilities, and a printer operator could select either a complementary printing mode or a gray level printing mode. For each single fixed pixel location 42 on the recording medium 16 shown in FIG. 8, zero, one or two ink droplets can be ejected onto that pixel location. FIG. 8 shows the three pixel locations 42a, 42b, 42c. In a first pixel location 42a, zero ink droplets are provided to create a first gray level. In a second pixel location 42b, only one droplet is provided to print spot 43, forming a second gray level. It should be appreciated that to create this gray level, either one of the aligned nozzles from nozzle array N1 or N2 could be used to eject a droplet onto the recording medium to form spot 43. In a third pixel location, two droplets are provided to print spot 44, one droplet from each of the aligned nozzles in each array N1 and N2 are used to eject a droplet onto the same spot on recording medium to form spot 44, thus creating a third gray level. Although the two droplets forming spot 44 are completely overlapping and would appear as substantially one larger spot, they are depicted as being slightly separated for emphasis and ease of understanding.

However, in an alternate embodiment, the placement of the two droplets on the same single pixel location can be electronically altered to provide almost a continuum of different overlap. By this technique, a continuum of density levels from a single droplet to completely non-overlapping of two droplets, are shown in FIG. 9. This continuum of overlapping spots is enabled by constructing logic in the printer controller 26 to instruct the printhead 12 or 12a to eject many droplets at a time. Thus, making the time to ripple droplets from the nozzle arrays short when compared to the time for the printhead to advance to the next pixel. After the first droplet is ejected from the leading array of nozzles N1, the second droplet ejected from the other array of nozzles N2 can be placed at any of several overlaps, thereby providing many more gray levels of printed information during a single pass of the printhead.

With continued reference to FIG. 9, six representative pixel locations are shown on recording medium 16. In a first pixel location 49, zero ink droplets are provided to form a first gray level. In a second pixel location 50, only one droplet is provided to print spot 55, forming a second gray level. Again, the spot 55 can be printed by a droplet ejected from nozzles in either nozzle array N1 or N2. In a third pixel location 51, two droplets are provided to print spot 56, one droplet from each of the aligned nozzles in each nozzle array N1 and N2. The second droplet to be printed to form spot 56 is specifically slightly shifted, so that spot 56 is slightly larger than spot 55, thus forming a third gray level. In a fourth pixel location 52, two droplets are provided to print spot 57, one droplet being provided by a nozzle from each of the two nozzle arrays N1 and N2, with the second droplet being shifted more than the second droplet of spot 56. Therefore, spot 57 is slightly larger than spot 56, thus forming a fourth gray level. In a fifth pixel location 53, two droplets are provided to print spot 58, with the second droplet being shifted more than the second droplet of spot 57, so that spot 58 is larger than spot 57, thus forming a fifth gray level. In a sixth pixel location 54, two droplets are provided to print spot 59, with the second droplet being placed next to the first printed droplet to form the largest spot and the sixth gray level. It should be appreciated that the varying shift of the second droplet may produce a continuum of spots and thus a continuum of gray levels. In addition to the gray levels produced by zero droplets and a single droplet, the gray levels vary from two slightly shifted but overlapping droplets to two non-overlapping droplets printed side-by-side.

Although the foregoing description illustrates the preferred embodiment, other variations are possible and all such variations as will be apparent to those skilled in the art intended to be included within the scope of this application as defined by the following claims.

What is claimed is:

1. A printhead for an ink jet printer that prints pixels on a recording medium in a complementary printing mode during a single pass, comprising:
a first and a second array of nozzles in the printhead, said first and second arrays of nozzles being substantially parallel to each other, and the nozzles in said first array of nozzles being in alignment with the nozzles in said second array of nozzles in a printing process direction; and
means for effecting selective ejection of ink droplets from each of the nozzles in said first and second arrays of nozzles during movement of said printhead in said printing process direction, said ink droplets from said first array of nozzles printing selected pixels of an image in each line of pixels on a recording medium, and said ink droplets from said second array of nozzles printing the remaining pixels of said image in each line of pixels not printed by ink droplets from said first array of nozzles, thereby said printing by said printhead mitigates any signature effect and any other systematic printing defects while printing a complete image swath in a single pass.

2. The printhead as claimed in claim 1, wherein said selected pixels in each line of pixels printed by ink droplets from said first array of nozzles are not adjacent each other; and wherein adjacent nozzles in said respective first and second array of nozzles do not concurrently eject ink droplets, so that said printhead ejects and prints ink droplets in a checkerboard pattern.

3. The printhead as claimed in claim 2, wherein said printhead has a roofshooter structure; and wherein said first and second arrays of nozzles are linear arrays.

4. The printhead as claimed in claim 3, wherein said printhead is a thermal ink jet printhead having selectively addressable resistors that eject ink droplets in response to electrical pulses are applied thereto.

5. The printhead as claimed in claim 1, wherein said printhead is a piezoelectric ink jet printhead having selectively addressable piezoelectric devices that selectively eject ink droplets when electric pulses are applied thereto.

6. The printhead as claimed in claim 5, wherein the nozzles in each array of nozzles are offset in at least two rows of nozzles in order to provide a spacing capable of high resolution printing of at least 600 spi in the printing process direction.

7. A method of complementary printing during a single pass by a printhead of an ink jet printer, comprising the steps of:
providing a first and a second array of nozzles in said printhead, said first and second array of nozzles being substantially parallel to each other;
aligning the nozzles of said first array of nozzles with said second array of nozzles in a printing process direction;
selectively applying electrical pulses to droplet ejectors associated with each printhead nozzle when a droplet ejection is required;
selectively ejecting ink droplets from each of the nozzles in said first and second arrays of nozzles during movement of said printhead in said printing process direction;
directing the ink droplets from said first array of nozzles to selected pixels of an image in each line of pixels on a recording medium; and
directing the ink droplets from said second array of nozzles to remaining pixels of said image in each line of pixels on said recording medium that were not printed by the ink droplets from said first array of nozzles, so that a complete image swath is produced in a single pass.

8. The method of complementary printing as claimed in claim 7, wherein said printhead has a roofshooter structure; and wherein said steps of directing ink droplets from said first and second array of nozzles directs said ink droplets to said pixels in each line of pixels that are not adjacent each other, so that adjacent nozzles in said first and second arrays do not concurrently eject ink droplets, thereby printing said ink droplets in a checkerboard pattern.

9. The printhead as claimed in claim 1, wherein said printhead comprises two separate adjacently mounted parts, one part having said first array of nozzles and the second part having said second array of nozzles.

10. A printhead for an ink jet printer capable of printing pixels on a recording medium in either a complementary printing mode or a gray level printing mode, each in a single pass, comprising:
a first and a second array of nozzles in the printhead, said first and second arrays of nozzles being substantially parallel to each other, the nozzles in said first array of nozzles being in alignment with the nozzles in said second array of nozzles in a printing process direction;
means for selectively ejecting ink droplets from each of the nozzles in said first and second arrays of nozzles during movement of said printhead in said printing process direction; and
when in the complementary printing mode, said ink droplets from the first array of nozzles printing selected pixels of an image in each line of pixels on the recording medium, and said ink droplets from said second array of nozzles printing the remaining pixels of said image is each line of pixels not printed by ink droplets from said first array of nozzles.

11. The printhead as claimed in claim 10, wherein when said printhead is in the gray level printing mode, said ink droplets from the first array of nozzles print selected pixels in each line of pixels on the recording medium, and said ink droplets from said second array of nozzles print over selected pixels printed by said first array of nozzles, so that each of the pixels may have one of at least three gray levels.

12. The printhead as claimed in claim 11, wherein a continuum of gray levels on a single pixel location on the recording medium can be created by ejecting two ink droplets thereon, one from each of said first and second arrays on nozzles in a manner such that each two ink droplets ejected onto said single pixel location have slightly varying degrees of overlap that range from two completely overlapped droplets to side-by-side, non-overlapping droplets on said pixel location.

13. The printhead as claimed in claim 10, wherein said printhead has a roofshooter structure; and wherein said printhead further comprises a controller for providing both said complementary and gray level printing modes, and either of said modes may be selected by a printer operator.
